(19) United States
(12) Patent Application Publication
(10) Pub. No.: US 2003/0141007 A1
(43) Pub. Date: Jul. 31, 2003

(54) Apparatus and method for manufacturing ceramic laminate

(76) Inventors: Hedeki Yoshikawa, Hyogo (JP); Takashi Umemoto, Osaka (JP); Keiichi Kuramoto, Osaka (JP); Hitoshi Hirano, Hyogo (JP)

Correspondence Address: FISH & RICHARDSON P.C., 45 ROCKEFELLER PLAZA, SUITE 2800, NEW YORK, NY, 10111, US

(21) Appl. No.: 10/352,742

(22) Filed: Jan. 28, 2003

(30) Foreign Application Priority Data
Jan. 28, 2002 (JP) P. 2002-017879

(51) Int. Cl. B32B 31/00

(52) U.S. Cl. 156/89.11; 156/381

(57) ABSTRACT

The space between a material sheet laminate 105 and the inner wall of a processing chamber 13a is filled with a buffer material. The material sheet laminate is heated in a firing furnace while the material sheet laminate is pressurized through the buffer material in a way of reducing the volume of a processing chamber 13a by loading of a weight 17. In this way, the material sheet laminate 105 is fired which it is pressurized from all the directions through the buffer material 14. This suppresses the warp of a ceramic laminate 100 due to the densification phenomenon occurring during the step of firing the material sheet laminate 105, thereby providing the ceramic laminate 100 with no warp.

### BACKGROUND OF THE INVENTION

This invention relates to an apparatus and method for manufacturing a ceramic laminated structure which is used as a laminate ceramic substrate board for a high frequency circuit.

Now, there is a continuing demand for miniaturization and sophistication of portable communication equipment such as a portable telephone. This leads to an increasing strict demand for miniaturization and sophistication for a high frequency circuit board used for the portable communication equipment.

In order to satisfy such a demand, there is a proposal of using, as a laminate ceramic board for a high frequency circuit, in place of a circuit board in which a capacitor and an inductor are surface-mounted, a ceramic laminate in which the capacitor and inductor are incorporated in the board itself for miniaturization by stacking a wiring pattern of the capacitor formed on a dielectric ceramic board and that of the inductor formed on a magnetic ceramic board.

FIG. 11A is a perspective view showing an example of a ceramic laminate. As seen from FIG. 11B, a ceramic laminate 100 is manufactured in such a way that a plurality of (three in an illustrated example) dielectric ceramic material sheets (substrates) 102A, 102B and 102C on which prescribed wiring patterns 101A, 101B and 101C constituting capacitors, respectively and a plurality of (three in the illustrated example) magnetic ceramic sheets 104A, 104B and 104C on which prescribed wiring patterns 103A, 103B and 103C constituting inductors, respectively are stacked on each other to form a material sheet laminate 105, and thereafter the material sheet laminate is collectively fired at a high temperature of about 800° C.-1300° C. The used dielectric ceramic material sheets 102A, 102B and 102C may be made of e.g. glass ceramic. The used magnetic ceramic material sheets 104A, 104b and 104C may be made of e.g. NiClZn system ferrite, Ba system hexagonal ferrite, etc.

The ceramic laminate 100, which can incorporate the inductor and capacitor in itself, it can reduce the number of inductors and capacitors as surface-mounted components. Therefore, using this ceramic laminate as a circuit board for a high frequency circuit can miniaturize a high frequency circuit module.

The ceramic laminate manufactured by the conventional technique presents a problem that as shown in FIG. 12c. A ceramic laminate 110 involves a warp generated owing to a difference in the shrinkage coefficient between the dielectric ceramic material sheet and the magnetic ceramic material sheet in the process of firing the stacked ceramic material sheets of different materials to form a single ceramic sintered body. The degree of warp depends on the kind and thickness of the ceramic material sheet, mixing ratio of a material powder and binder, granule diameter and shape of the material powder, firing condition, etc.

Where there is no warp in the ceramic laminate 110, as seen from FIG. 12A, there is no disconnection in the electrical contact between the wiring patterns 113 and 114 formed on ceramic material sheets 111 and 112 adjacent to each other, respectively. On the other hand, where there is a warp in the ceramic laminate 110, as seen from FIG. 12B, the wiring patterns 113 and 114 formed on ceramic material sheets 111 and 112 adjacent to each other may be separated from each other owing to peeling of the ceramic material sheets 111 and 112 from each other. In such a case, the wiring resistance is increased so that the characteristic of a high frequency circuit module is greatly deteriorated. Further, if the warp increases, as seen from FIG. 12C, the ceramic laminate 110 involves breakage 115, thereby greatly reducing the production yield.

### SUMMARY OF THE INVENTION

This invention has been accomplished in view of the circumstance described above, and intends to provide an apparatus and method capable of manufacturing a ceramic laminate with no warp by stacking ceramic material sheets on each other.

Particularly, this invention intends to correct the warp by uniformly applying mechanical stress to the ceramic laminate when combined green sheets such as dielectric, magnetic material, etc. with different shrinkage coefficients are simultaneously fired.

In order to attain the above object, the manufacturing apparatus according to this invention is a ceramic laminate manufacturing apparatus for integrating a material sheet laminate formed of at least one layer of stacked ceramic material sheets comprises: a sealed processing chamber for accommodating the material sheet laminate; a pressuring means for pressuring the material sheet laminate by reducing the volume of the processing chamber; a deformable buffer material which intervenes between the internal wall of the processing chamber and the material sheet laminate; and a heating means for heating the material sheet laminate.

This manufacturing device is effectively employed where the ceramic material sheet is a “green sheet” before it is fired and a ceramic material sheet after it has been fired.

Preferably, the material sheet laminate includes a green sheet, and the heating means includes a firing means for firing the green sheet.

In the apparatus for manufacturing a ceramic laminate according to this invention, preferably, an entire region between the inner wall of the processing chamber and the material sheet laminate is filled with the buffer material.

The pressurizing means may include a pair of pressurizing members which constitute a part of the wall of the processing chamber and pressurizes the material sheet laminate so as to be sandwiched from both sides in a stacking direction, and the buffer material may be caused to intervene between the pressurizing member and the material sheet laminate.

The buffer material is made of a material which is not thermally changed at a temperature in which the ceramic material sheets are bonded to each other.

Preferably, the buffer material is made of a plastic metal. The buffer material is in the form of powder or thin film belt.

The material sheet laminate is composed of at least one dielectric ceramic material sheet and at least one magnetic ceramic material sheet which are stacked on each other.

In accordance with the manufacturing apparatus according to this invention constructed as described above, the space between the material sheet laminate and the inner wall of the processing chamber is filled with a buffer material, and the material sheet laminate is heated in a firing furnace while the material sheet laminate is pressurized through the buffer material in a way of reducing the volume of a processing chamber. In this way, the material sheet laminate can be fired while it is pressurized through the buffer material. This suppresses the warp of a ceramic laminate, thereby providing a ceramic laminate with no warp. Also when a green sheet is fired in a step of integrating the laminate, the warp of the ceramic laminate due to the densification phenomenon occurring during the step of firing the material sheet laminate can be suppressed.

In order to attain the above object, the method of manufacturing a ceramic laminate according to this invention is a method of manufacturing an integrated ceramic laminate by firing a material sheet laminate while it is heated at a firing temperature, the material sheet laminate being composed of at least one of each of ceramic material sheets having different thermal shrinkage coefficients stacked to each other, with the material sheet laminate being accommodated in a sealed processing chamber and a deformable buffer material being arranged between the inner wall of the processing chamber and the material sheet laminate, the material sheet laminate is subjected to heat treatment while it is pressurized through a buffer material by reducing the volume of the processing chamber.

In a method for manufacturing a ceramic laminate according to this invention, preferably, an entire region between the inner wall of the processing chamber and the material sheet laminate is filled with the buffer material.

The pressurizing means includes a pair of pressurizing members which constitute a part of the wall of the processing chamber and pressurizes the material sheet laminate so as to be sandwiched from both sides in a stacking direction, and the buffer material may be caused to intervene between the pair of pressurizing members and the material sheet laminate.

Preferably, the buffer material is made of a plastic metal. The buffer material may be in the form of powder or thin film belt.

Preferably, the buffer material is powder having a particle diameter of 0.1-3 μm. The particle diameter of 0.1-3 μm assures good fluidity.

Preferably, the material sheet laminate is composed of at least one dielectric ceramic material sheet and at least one magnetic ceramic material sheet which are stacked to each other.

In accordance with the manufacturing method according to this invention constructed as described above, the space between the material sheet laminate and the inner wall of the processing chamber is filled with a buffer material, and the material sheet laminate is heated in a firing furnace while the material sheet laminate is pressurized through the buffer material in a way of reducing the volume of a processing chamber. In this way, the material sheet laminate can be fired while it is pressurized through the buffer material. This suppresses the warp of a ceramic laminate due to the densification phenomenon occurring during the step of firing the material sheet laminate, thereby providing the ceramic laminate with no warp.

### BRIEF DESCRIPTION OF THE DRAWINGS

FIG. 1a is an exploded perspective view of a first embodiment of the manufacturing apparatus according to this invention;

FIG. 1B is a sectional view;

FIGS. 2A to 2C are manufacturing flowcharts showing an example of the method of manufacturing the ceramic laminate using the manufacturing apparatus shown in FIGS. 1A and 1B;

FIG. 3A is an exploded perspective view of a second embodiment of the manufacturing apparatus according to this invention;

FIG. 3B is a sectional view;

FIGS. 4A to 4C are manufacturing flowcharts showing an example of the method of manufacturing the ceramic laminate using the manufacturing apparatus shown in FIGS. 3A and 3B;

FIG. 5A is an exploded perspective view of a third embodiment of the manufacturing apparatus according to this invention;

FIG. 5B is a sectional view;

FIGS. 6A to 6C are manufacturing flowcharts showing an example of the method of manufacturing the ceramic laminate using the manufacturing apparatus shown in FIGS. 5A and 5B;

FIG. 7A is a perspective view of a fourth embodiment of the manufacturing apparatus according to this invention;

FIG. 7B is a sectional view;

FIG. 8 is a sectional view of a fifth embodiment of the manufacturing apparatus according to this invention;

FIG. 9 is a sectional view of the ceramic laminate manufactured by the manufacturing apparatus and manufacturing method according to this invention;

FIG. 10A is an appearance view of the ceramic laminate manufactured without being pressurized through the firing step;

FIG. 10B is an appearance view of the ceramic laminate manufactured by the manufacturing method according to this invention;

FIG. 11A is a perspective view of an exemplary structure of a ceramic laminate;

FIG. 11B is an exploded perspective view;

FIG. 12A is a sectional view of a connecting state of wiring patterns when a ceramic laminate does not have warp;

FIG. 12B is a sectional view of a connecting state of wiring patterns when a ceramic laminate has warp; and

FIG. 12C is a side view showing the state where warp occurred in the ceramic laminate.

### DETAILED DESCRIPTION OF THE PREFERRED EMBODIMENTS

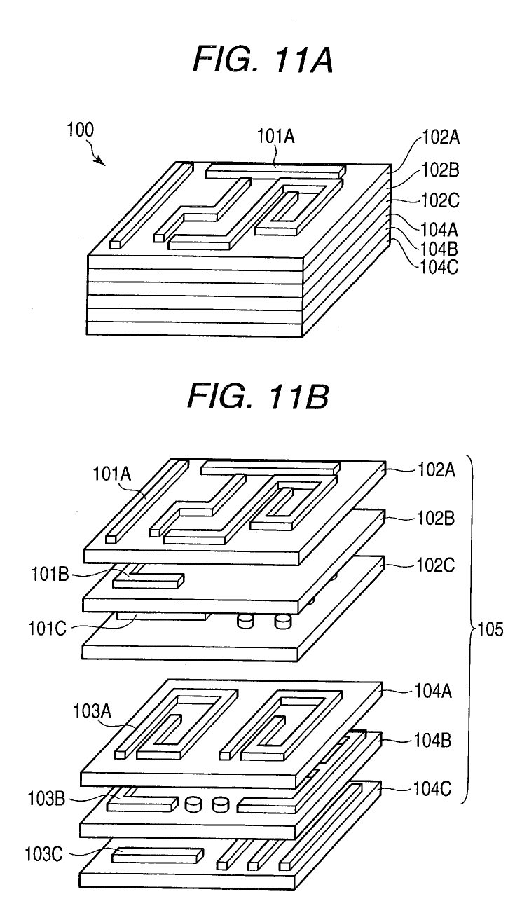

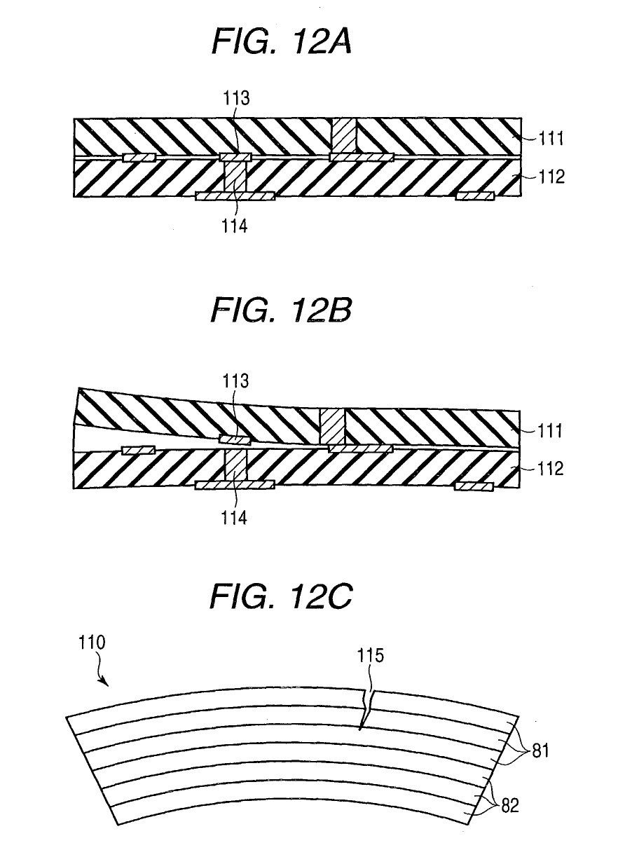

An explanation will be given of various embodiments of this invention. The explanation will be given of the case where the ceramic laminate having a structure shown in FIG. 11A is manufactured.

Embodiment 1

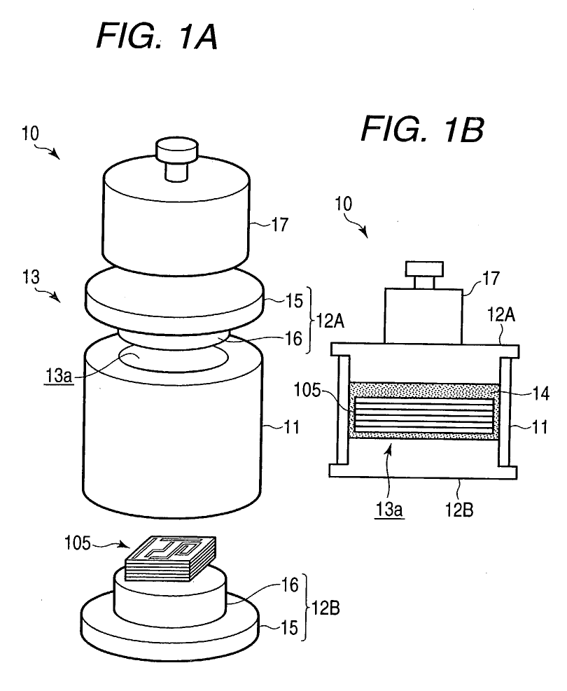

FIG. 1A is an exploded perspective view of a first embodiment of a manufacturing apparatus according to this invention, and FIG. 1B is a sectional view.

As seen from these figures, a manufacturing apparatus 10 according to the first embodiment includes a cylindrical body member 11, a pressurizing jig 13 composed of a pair of pressurizing members 12A and 12B which are fit to the body member 11 from above and below, a buffer material 14 arranged between a material sheet (green sheet) laminate 105 which is accommodated within a processing chamber 13a of the pressurizing jig 13 and an inner wall of the processing chamber 13, a weight 17 which pressurizes the upper pressurizing member 12A of the pressurizing jig 13 from above, and a firing furnace (heating means) (not shown) for heating the interior of the processing chamber 13a through the pressurizing jig 13.

The body member 11 and pressurizing members 12A, 12B which constitute the pressurizing jig 13 are made of the material which is not thermally changed at a firing temperature (800° C.-1300° C.) of the material sheet laminate 105. Each of the pressurizing members 12A and 12B is integrally composed of a disk-like end plate 15, which has a larger diameter than the outer diameter of the body member 11, and a disk-like fitting portion (projection) which is intimately fit to the internal wall of the body member 11. The space which is encircled by the inner wall of the body member 11 and the inner faces (end faces of the fitting portions 16) of the pressurizing members 12A, 12B constitute a processing chamber 13a.

The buffer material 14 is made of powder of the material which does not change at the firing temperature (800-1300° C.) of the sheet laminate 105, e.g. fine powder of alumina.

An explanation will be given of a method for manufacturing the ceramic laminate 100 using the manufacturing apparatus 10 according to this embodiment.

First, as in the case of FIG. 11B, a six-layer structure material sheet laminate 105 is manufactured in such a way that three dielectric ceramic material sheets 102A, 102B and 102C on which prescribed patterns 101A, 101B and 101C constituting capacitors, respectively and three magnetic sheets 104A, 104B and 104C on which prescribed patterns 103A, 103B and 103C constituting inductors, respectively are stacked on each other.

Next, the material sheet laminate 105 is set within the processing chamber 13a of the pressuring jig 13.

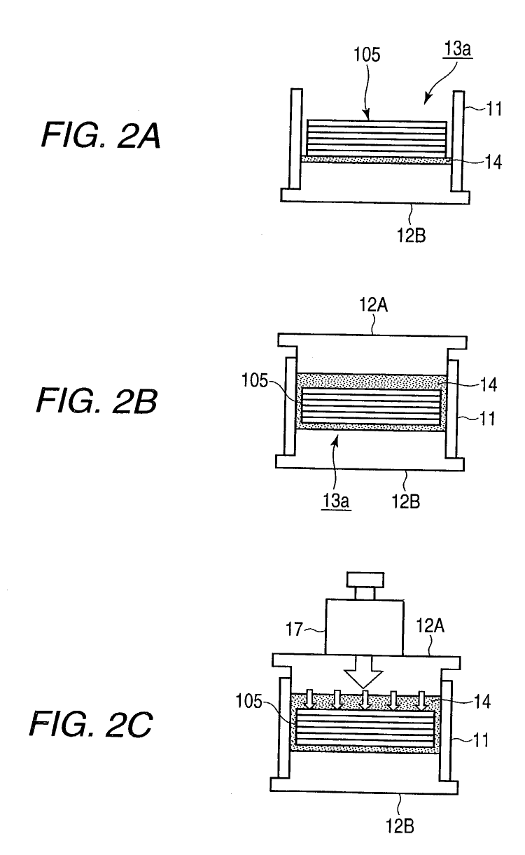

In this case, as shown in FIG. 2A, with the lower pressuring member 12B fit in the body member 11, the material sheet laminate 105 is placed on the buffer material 14 previously put on the bottom of the processing chamber 13a. As seen from FIG. 2B, the buffer material 14 is poured in the processing chamber 13a until the material sheet laminate 105 is entirely embedded in the buffer material 14 and no gap remains within the processing chamber 13a. Thereafter, the upper pressuring member 12A is fit in the body member 11.

Further, as seen from FIG. 2C, with the weight 17 placed on the upper pressuring member 12A of the pressuring jig 13, the pressurizing jig 13 is set within the firing furnace 13, and the interior of the processing chamber 13a is heated for a prescribed time through the pressuring jig 13. The heating temperature is set at the firing temperature of the material sheet laminate 105. This heating treatment sinters the material sheet laminate 105 to constitute the integrated ceramic laminate 100.

The pressurizing jig 13 is taken out from the firing furnace 13. The pressurizing jig 13 is cooled to room temperature and thereafter dismantled to take out the ceramic laminate 100.

As described above, the space between the material sheet laminate 105 and the inner wall of the processing chamber 13a is filled with the buffer material 14, and with the weight 17 placed on the upper pressurizing member 12A of the pressurizing jig 13, the processing chamber 13a is pressurized from above. In this way, the processing chamber 13a receives pressure of reducing the volume. The pressure acts on the buffer material 14 from the inner wall of the processing chamber 13a. Thus, the pressure is uniformly applied to the material sheet laminate 105 from all directions.

In this state, i.e. the state where the material sheet laminate 105 is being pressurized through the buffer material 14, by performing the heating treatment of firing the material sheet laminate 105 and the cooling treatment of cooling it to the room temperature, deformation of the material sheet laminate in all directions during the heating treatment and cooling treatment is suppressed.

This suppresses the warp of the ceramic laminate 100 due to the densification phenomenon occurring during the step of firing the material sheet laminate 105 and shrinkage phenomenon occurring during the step of cooling the material sheet laminate 105 to room temperature.

Therefore, in accordance with the first embodiment, the separation of the wiring patterns from each other or the breakage of the ceramic laminate 100 due to the warp of the ceramic laminate 100 can be prevented, thereby improving the production yield.

Further, since the pressurizing jig can be easily handled and used many times, the ceramic laminate 100 free from its breakage and separation of the wiring patterns from each other can be manufactured at low cost.

Embodiment 2

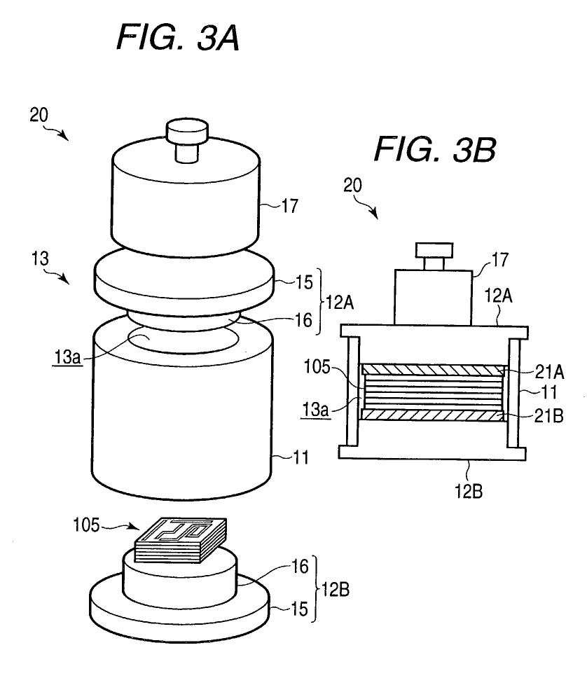

FIG. 3A is an exploded perspective view showing the second embodiment of the manufacturing apparatus according to this invention. FIG. 3B is a sectional view.

A manufacturing apparatus 20 according to the second embodiment includes a pressurizing jig 13, a weight 17 and firing furnace (heating means) not shown each having the same structure as that of the first embodiment shown in FIG. 1. This embodiment is different from the first embodiment in that buffer materials 21A and 21B are caused to lie only between the upper and lower pressurizing members 12A and 12B and the material sheet laminate 105.

The buffer materials 21A and 21B are thin film belts, e.g. platinum thin belts, made of the metallic material having a high melting point which is not molten at the firing temperature of the material sheet laminate 105 and having high malleability.

The ceramic laminate 100 is manufactured using the manufacturing apparatus 20 according to this second embodiment as follows.

First, as in the case of FIG. 11B, a six-layer structure material sheet laminate 105 is manufactured in such a way that three dielectric ceramic material sheets (green sheets) 102A, 102B and 102C on which prescribed patterns 101A, 101B and 101C constituting capacitors, respectively and three magnetic sheets 104A, 104B and 104C on which prescribed patterns 103A, 103B and 103C constituting inductors, respectively are stacked on each other.

Next, the sheet laminate 105 is set within the processing chamber 13a of the pressuring jig 13.

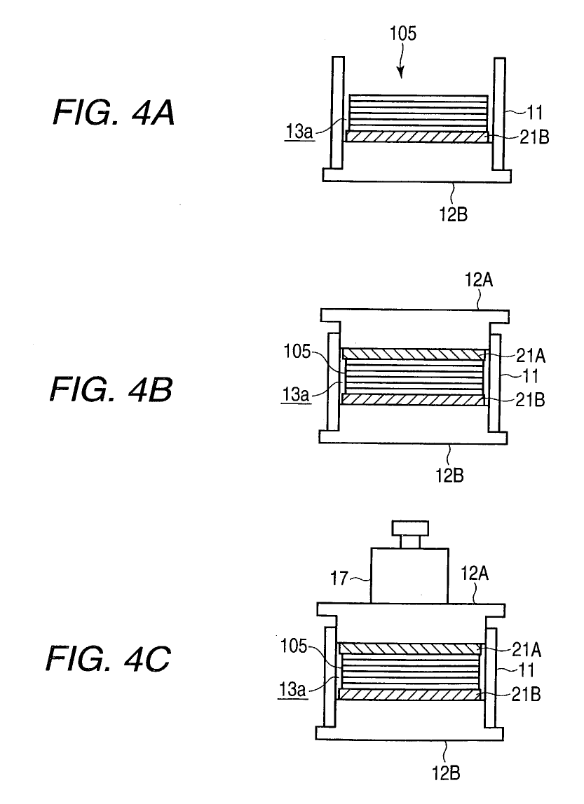

In this case, as shown in FIG. 4A, with the lower pressuring member 12B fit in the body member 11, the sheet laminate 105 is placed on the buffer material 21B previously put on the bottom of the processing chamber 13a. As seen from FIG. 4B, the buffer material 21A is placed on the material sheet laminate 105 and thereafter the upper pressurizing member 12A is fit in the body member 11.

Further, as seen from FIG. 4C, with the weight 17 placed on the upper pressuring member 12A of the pressuring jig 13, the pressurizing jig 13 is set within the firing furnace 13, and the interior of the processing chamber 13a is heated for a prescribed time through the pressuring jig 13. The heating temperature is set at the firing temperature of the material sheet laminate 105. This heating treatment sinters the material sheet laminate 105 to constitute the integrated ceramic laminate 100.

The pressurizing jig 13 is taken out from the firing furnace 13. The pressurizing jig 13 is cooled to room temperature and thereafter dismantled to take out the ceramic laminate 100.

As described above, with the buffer materials 21A and 21B placed between the material sheet laminate 105 and the pair of pressuring members 12A and 12B which are arranged so as to sandwich the material sheet laminate 105 from above and below, the upper pressurizing member 12A is pressurized by the weight of the weight 17. In this way, the processing chamber 13a receives pressure of reducing the volume. The pressure acts on the buffer materials 21A and 21B from both pressurizing members 12A and 12B. Thus, the pressure is uniformly applied to both upper and lower surfaces of the material sheet laminate 105 through the buffer materials 21A and 21B from the stacking direction (vertical direction)

In this state, i.e. the state where the material sheet laminate 105 is being uniformly pressurized through the buffer materials 21A and 21B from the stacking direction, by performing the heating treatment of firing the material sheet laminate 105 and the cooling treatment of cooling it to the room temperature, deformation of the material sheet laminate in the stacking direction during the heating treatment and cooling treatment is suppressed.

This suppresses the warp of the ceramic laminate 100 due to the densification phenomenon occurring during the step of firing the material sheet laminate 105 and shrinkage phenomenon occurring during the step of cooling the material sheet laminate 105 to ordinary temperature.

Therefore, in accordance with the first embodiment, the separation of the wiring patterns from each other or the breakage of the ceramic laminate 100 due to the warp of the ceramic laminate 100 can be prevented, thereby improving the production yield.

Embodiment 3

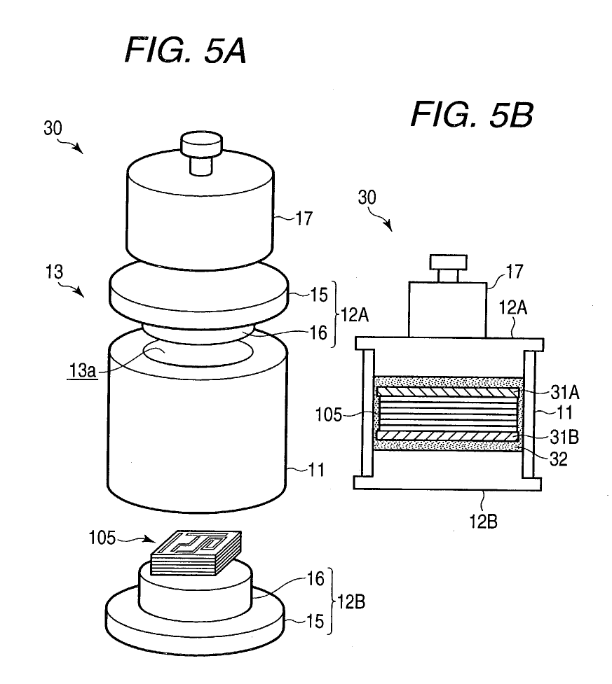

FIG. 5A is an exploded perspective view showing the second embodiment of the manufacturing apparatus according to this invention. FIG. 5B is a sectional view.

A manufacturing apparatus 30 according to the third embodiment includes a pressurizing jig 13, a weight 17 and firing furnace (heating means) not shown each having the same structure as that of the first embodiment shown in FIG. 1. This embodiment is different from the first embodiment in that sheet-like buffer materials 31A and 31B are caused to lie between the upper and lower pressurizing members 12A and 12B and the material sheet (green sheet) laminate 105, and the gap within the processing chamber 13a is filled with buffer material powder 32.

The buffer materials 31A and 31B are thin film belts, e.g. platinum thin belts, made of the metallic material having a high melting point which is not molten at the firing temperature of the material sheet laminate 105 and having high malleability.

The buffer material 32 is powder of the material which is not fired at the firing temperature of the material sheet laminate 105, e.g. fine powder of alumina.

The ceramic laminate 100 is manufactured using the manufacturing apparatus 30 according to this second embodiment as follows.

First, as in the case of FIG. 11B, a six-layer structure material sheet laminate 105 is manufactured in such a way that three dielectric ceramic material sheets (green sheets) 102A, 102B and 102C on which prescribed patterns 101A, 101B and 101C constituting capacitors, respectively and three magnetic sheets 104A, 104B and 104C on which prescribed patterns 103A, 103B and 103C constituting inductors, respectively are stacked on each other.

Next, the sheet laminate 105 is set within the processing chamber 13a of the pressuring jig 13.

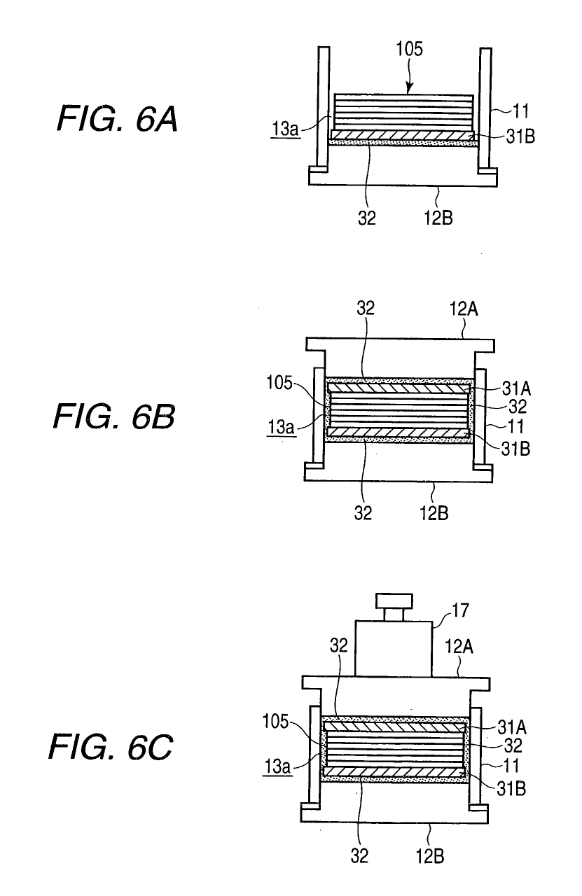

In this case, as shown in FIG. 6A, with the lower pressuring member 12B fit in the body member 11, the sheet laminate 105 is placed on the buffer materials 32B and 31B previously put on the bottom of the processing chamber 13a. As seen from FIG. 6B, the buffer material 31A is placed on the material sheet laminate 105 and the gap within the processing chamber 13a is filled with the buffer material to reach the position of the upper surface of the buffer material 31A, and thereafter the upper pressurizing member 12A is fit in the body member 11.

Further, as seen from FIG. 6C, with the weight 17 placed on the upper pressuring member 12A of the pressuring jig 13, the pressurizing jig 13 is set within the firing furnace 13, and the interior of the processing chamber 13a is heated for a prescribed time through the pressuring jig 13. The heating temperature is set at the firing temperature of the material sheet laminate 105. This heating treatment sinters the material sheet laminate 105 to constitute the integrated ceramic laminate 100.

The pressurizing jig 13 is taken out from the firing furnace 13. The pressurizing jig 13 is cooled to room temperature and thereafter dismantled to take out the ceramic laminate 100.

As described above, with the sheet-like buffer materials 31A and 31B placed between the material sheet laminate 105 and the pair of pressuring members 12A and 12B which are arranged so as to sandwich the material sheet laminate 105 from above and below, and with the gap within the processing chamber 13a being filled with the powder-like buffer material 32, the upper pressurizing member 12A is pressurized by the weight of the weight 17. In this way, the processing chamber 13a receives pressure of reducing the volume. The pressure acts on the buffer materials 31A, 31B and 32 from both pressurizing members 12A and 12B. Thus, the pressure is uniformly applied to the material sheet laminate 105 through the buffer materials 31A, 31B and 32 from all the directions.

In this state, i.e. the state where the entire material sheet laminate 105 is being uniformly pressurized through the buffer materials 31A, 31B and 32 from all the directions, by performing the heating treatment of firing the material sheet laminate 105 and the cooling treatment of cooling it to the room temperature, deformation of the material sheet laminate in the stacking direction during the heating treatment and cooling treatment is suppressed.

This suppresses the warp of the ceramic laminate 100 due to the densification phenomenon occurring during the step of firing the material sheet laminate 105 and shrinkage phenomenon occurring during the step of cooling the material sheet laminate 105 to room temperature.

Embodiment 4

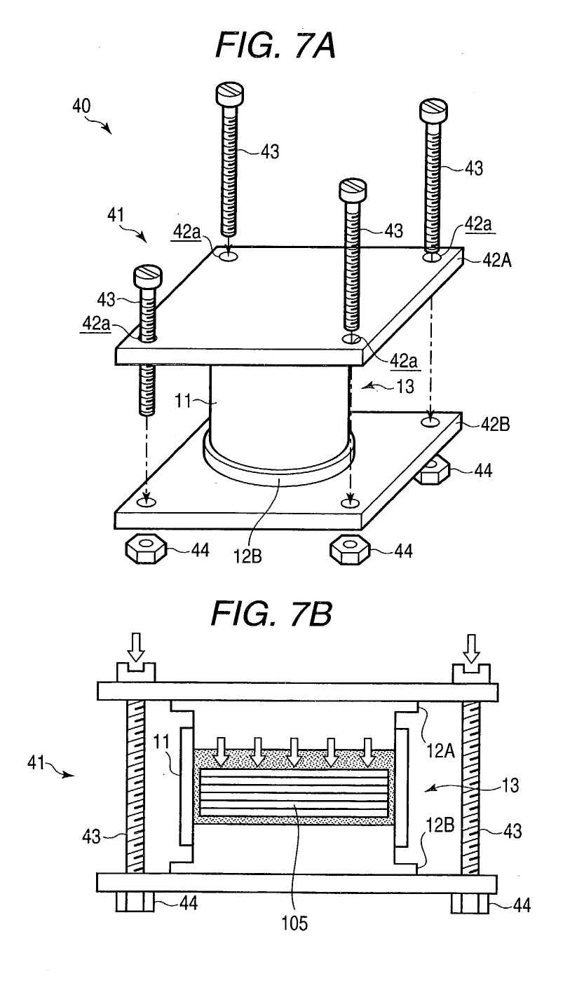

FIG. 7A is an exploded perspective view showing the second embodiment of the manufacturing apparatus according to this invention. FIG. 7B is a sectional view.

A manufacturing apparatus 40 according to the fourth embodiment includes a pressurizing jig 13 and firing furnace (heating means) not shown each having the same structure as that of the first embodiment shown in FIG. 1. This embodiment is different from the first embodiment in that a pressurizing device 41 for pressurizing the pressurizing jig so as to be sandwiched from both above and below.

The pressurizing device 41 includes a pair of upper and lower sandwiching plates 42A, 42B, four clamping bolts 43 having equal lengths which are passed through through-holes 42a formed at four corners of both sandwiching plates 42A, 42B and four nuts 44 which are engaged with the clamping bolts 43.

The sandwiching plates 42A, 42B, clamping bolt 43 and nut 44 are made of the material which is not deformed nor molten at the temperature of firing the material sheet laminate, i.e. oxide material having high heat-resistance such as alumina.

The ceramic laminate 100 is manufactured using the manufacturing apparatus 40 according to this fourth embodiment as follows.

Like the first embodiment, as shown in FIG. 2A, with the lower pressuring member 12B fit in the body member 11, the material sheet laminate 105 is placed on the buffer material 14 previously put on the bottom of the processing chamber 13a. As seen from FIG. 2B, the buffer material 14 is poured in the processing chamber 13a until the material sheet laminate 105 is entirely embedded in the buffer material 14 and no gap remains within the processing chamber 13a. Thereafter, the upper pressuring member 12A is fit in the body member 11.

Thereafter, as seen from FIG. 7A, the pressurizing jig 13 is sandwiched by the sandwiching plates 42A and 42B of the pressurizing device 41 from above and below, the locking bolts 43 are passed through the through-holes 42a at all the four corners 42a and the nuts 44 are engaged with the locking bolts 43, respectively. The respective locking bolts 43 and nuts 44 are spun in a tightening direction to decrease the interval between the upper and lower sandwiching plates 42A and 42B. Further, as seen from FIG. 7B, the upper and lower sandwiching plates 42A and 42B are brought into pressure-contact with the upper and lower pressurizing members 12A and 12B so that the pressurizing jig 13 sandwiched by the upper and lower sandwiching plates 42A and 42B from above and below is pressurized.

Thereafter, the pressurizing jig 13 as well as the pressurizing device 41 is set in the firing furnace and heated for a prescribed time. The heating temperature is set at the firing temperature of the material sheet laminate 105. This heating treatment sinters the material sheet laminate 105 to constitute the integrated ceramic laminate 100.

The pressurizing device 41 and pressurizing jig 13 are taken out from the firing furnace 13 and cooled to room temperature. They are thereafter dismantled to take out the ceramic laminate 100.

As described above, with the gap between the material sheet laminate 105 and inner wall of the processing chamber 13a being filled with the buffer material 14, and with the pressurizing jig 13 sandwiched by the pressuring device 41 from both above and below being pressurized, by performing the heating treatment of firing the material sheet laminate 105 and the cooling treatment of cooling it to the room temperature, like the case of the first embodiment, deformation of the material sheet laminate in all the directions during the heating treatment and cooling treatment is suppressed. Therefore, the separation of the wiring patterns from each other or the breakage of the ceramic laminate 100 due to the warp of the ceramic laminate 100 can be prevented.

Even when half-contact state occurs in which the material sheet laminate 105 and pressurizing members 12A, 12B are in partial contact with each other, owing to volume shrinkage of the material sheet laminate 105 due to densification and thermal deformation of the pressurizing jig 13 or pressurizing device 41, since contact failure is absorbed by the powder-like buffer material 14, uniform pressure is always applied to the material sheet laminate 105.

Embodiment 5

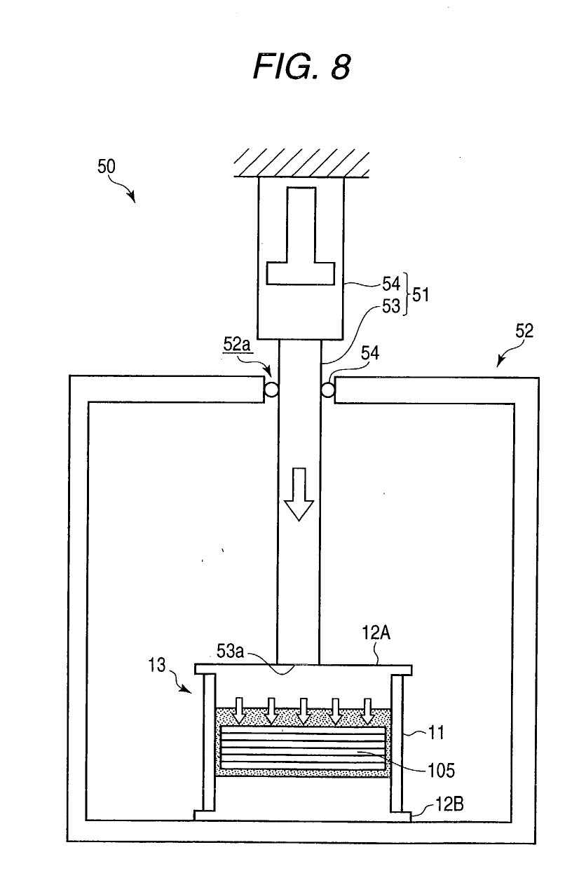

FIG. 8 is a sectional view of a fifth embodiment of the manufacturing device according to this invention.

The manufacturing device 50 of the fifth embodiment has the pressurizing jig 13 having the same structure as that of the first embodiment. This embodiment is different from the first embodiment in that a pressurizing device 51 for pressurizing the pressurizing jig 13 from above is provided in place of the weight 17, and the structure of the firing furnace 52 is changed.

The pressurizing device 51 includes a pressurizing rod 53 which extends vertically and a cylinder device 54 for moving the pressurizing rod 53 vertically. The pressurizing rod 53 is inserted into a furnace chamber through a through-hole 52a made centrally in a ceiling wall of the body of a firing furnace 52 and has a tip 53a kept in contact with the upper surface of the pressurizing jig 13, i.e. the upper pressurizing member 12A. The cylinder device 54 is installed at a prescribed position, and depresses the pressurizing member 12A through the pressurizing rod 53.

The ceramic laminate 100 is manufactured using the manufacturing apparatus 40 according to this fourth embodiment as follows.

Like the first embodiment, as shown in FIG. 2A, with the lower pressuring member 12B fit in the body member 11, the material sheet laminate 105 is placed on the buffer material 14 previously put on the bottom of the processing chamber 13a. As seen from FIG. 2B, the buffer material 14 is poured in the processing chamber 13a until the material sheet laminate 105 is entirely embedded in the buffer material 14 and no gap remains within the processing chamber 13a. Thereafter, the upper pressuring member 12A is fit in the body member 11.

Thereafter, with the pressurizing jig 13 centrally put on the floor of the furnace body of the firing furnace 52, as shown in FIG. 8, the pressurizing member 12A pressurized by the pressurizing device 51 is heated for a prescribed time. The pressurizing force is set by controlling the output from the cylinder device 54. The heating temperature is set at the firing temperature of the material sheet laminate 105. This heating treatment sinters the material sheet laminate 105 to constitute the integrated ceramic laminate 100.

Therefore, pressurizing by the pressurizing device 51 is released, and the pressurizing jig 13 is taken out from the firing furnace 52 and cooled to room temperature. The pressurizing jig 13 is dismantled to takeout the ceramic laminate 100.

As described above, with the gap between the material sheet laminate 105 and inner wall of the processing chamber 13a being filled with the powder-like buffer material 14, and with the pressurizing jig 13 pressurized by the pressuring device 41, by performing the heating treatment of firing the material sheet laminate 105 and the cooling treatment of cooling it to the room temperature, like the case of the first embodiment, deformation of the material sheet laminate 105 in all the directions during the heating treatment and cooling treatment is suppressed. Therefore, the separation of the wiring patterns from each other or the breakage of the ceramic laminate 100 due to the warp of the ceramic laminate 100 can be prevented.

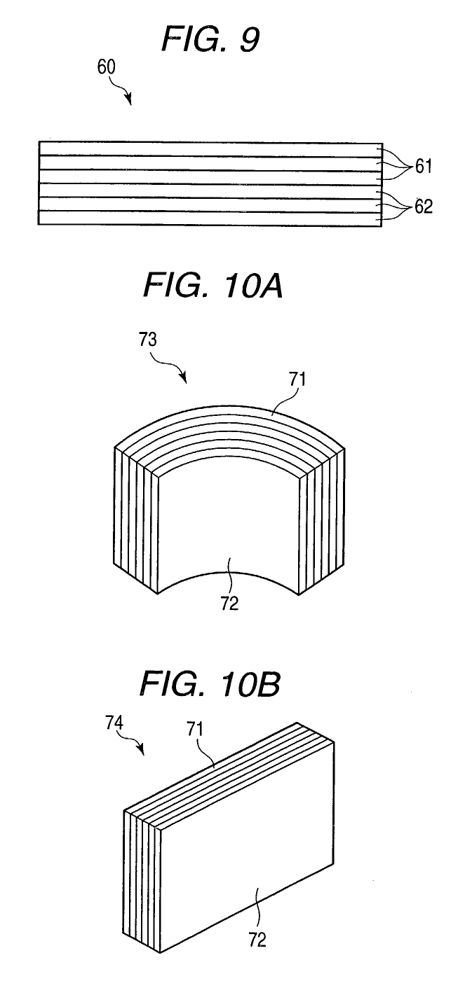

In any one of the first to fifth embodiments as described above, throughout the heating treatment of firing the material sheet laminate 105 and the cooling treatment of cooling it to room temperature, uniform pressure is continuously applied to the material sheet laminate via the buffer material from all the directions or stacking direction. Therefore, deformation of the ceramic laminate during the process of simultaneous firing at a high temperature and cooling of different materials is suppressed so that the ceramic laminate 60 free from warp and peeling as shown in FIG. 9 can be obtained, thereby improving the production yield. FIG. 9 shows an example in which dielectric ceramic material sheets 61 and magnetic ceramic material sheets 62 which have equal thicknesses and thermal shrinkage coefficients are stacked and fired. Irrespectively of whether or not firing is performed during the integrating step, also in a structure in which the ceramic material sheets having equal shrinkage coefficients and different thicknesses are stacked and integrated, the ceramic laminate with no warp and peeling can be obtained.

Further, since the ceramic laminate is manufactured using the pressurizing jig can be easily handled and used many times, the ceramic laminate 100 free from its breakage and separation of the wiring patterns from each other can be manufactured at low cost.

Since the ceramic laminate having the advantages described above can have a wide range of C value of a capacitor and L value of an inductor, by reducing the number of inductors and capacitors which are surface-mounted components, the high frequency circuit module can be miniaturized. Particularly, by employing a ferroelectric material such as barium titanate as a material for the dielectric ceramic material sheet and employing a high frequency magnetic material such as NiCuZn ferrite for the magnetic ceramic material sheet, a wider range of C value and L value than in the ceramic laminate using alumina can be obtained, thereby further miniaturizing the high frequency circuit module.

FIGS. 10A and 10B are appearance views of the ceramic laminates which have been actually manufactured. Both ceramic laminates 73 and 74 each is a structure in which magnetic ceramic material sheets 71 of Ba-system hexagonal ferrite and dielectric ceramic material sheets 72 each of which is a general LTC sheet are stacked and integrated.

FIG. 10A shows the structure in which the magnetic ceramic material sheets 71 and dielectric ceramic material sheets 72 have been combined without being pressurized through the firing process. Owing to a difference in the thermal characteristic (expansion coefficient, shrinkage coefficient, etc.) between both sheets, the ceramic laminate produces warp and separation during the heat treatment so that the ceramic laminate with different kinds of ceramic material sheets combined satisfactorily could not be realized.

On the other hand, FIG. 10B shows the structure in which the magnetic ceramic material sheets 71 and the dielectric ceramic material sheets 72 have been combined while load of 20 g/cm² is being applied using the alumina powder having an average grain diameter of 3 μm as a buffer material. It can been seen that the ceramic laminate free from the warp and separation could be realized.

In the embodiments described above, uniform pressure was continuously applied to the material sheet laminate through the buffer material from all the directions or stacking direction during the heating treatment of firing the material sheet laminate and the cooling treatment of cooling it to room temperature. However, the uniform pressure may be applied through the buffer material only during the heating treatment.

In the embodiments described above, the composite ceramic laminates in each of which the ceramic material sheets of different kinds of material, i.e. dielectric and magnetic material were explained. However, this invention can be also applied to the ceramic laminate in which the ceramic material sheets of the same material. Namely, this invention can also be applied to the dielectric ceramic laminate in which only a plurality of layers of dielectric ceramic material sheets are stacked or only a plurality of layers of magnetic ceramic material sheets are stacked.

As described above, in accordance with this invention, by performing the heating treatment while the material sheet laminate is pressurized through the buffer material, even if there is a difference in the thermal shrinkage coefficient between the ceramic material sheets, occurrence of deformation can be prevented to provide the ceramic laminate.

What is claimed is:

1. A ceramic laminate manufacturing apparatus for integrating a material sheet laminate formed of at least one layer of stacked ceramic material sheets, comprising:
a sealed processing chamber for accommodating said material sheet laminate;
a pressuring means for pressuring said material sheet laminate by reducing the volume of said processing chamber;
a deformable buffer material which intervenes between the internal wall of the processing chamber and said material sheet laminate; and
a heating means for heating said material sheet laminate.

2. A ceramic laminate manufacturing apparatus according to claim 1, wherein said material sheet laminate includes a green sheet, and said heating means includes a firing means for firing the green sheet.

3. A ceramic laminate manufacturing apparatus according to claim 1, wherein an entire region between the inner wall of said processing chamber and said material sheet laminate is filled with said buffer material.

4. A ceramic laminate manufacturing apparatus according to claim 1, wherein said pressurizing means includes a pair of pressurizing members which constitute a part of the wall of said processing chamber and pressurizes said material sheet laminate so as to be sandwiched from both sides in a stacking direction, and
said buffer material is caused to intervene between said pressurizing member and said material sheet laminate.

5. A ceramic laminate manufacturing apparatus according to claim 1, wherein said buffer material is made of a material which is not thermally changed at a temperature in which the ceramic material sheets are bonded to each other.

6. A ceramic laminate manufacturing apparatus according to claim 5, wherein said buffer material is made of a plastic metal.

7. A ceramic laminate manufacturing apparatus according to claim 5, wherein said buffer material is in the form of powder or thin film belt.

8. A ceramic laminate manufacturing apparatus according to claim 5, wherein said buffer material is powder having a particle diameter of 0.1-3 μm.

9. A ceramic laminate manufacturing apparatus according to claim 1, wherein said material sheet laminate is composed of at least one dielectric ceramic material sheet and at least one magnetic ceramic material sheet which are stacked to each other.

10. A ceramic laminate manufacturing apparatus according to claim 1, wherein said ceramic material sheet includes material sheets having different thermal shrinkage coefficients.

11. A method for manufacturing a ceramic laminate comprising the steps of:
accommodating a material sheet laminate composed of stacked ceramic material sheets in a sealed processing chamber;
arranging a deformable buffer material between the inner wall of said processing chamber and the material sheet laminate;
heat-treating said material sheet while it is pressurized through the buffer material by reducing the volume of said processing chamber.

12. A ceramic laminate manufacturing method according to claim 11, wherein said material sheet laminate includes a green sheet, and the heat treatment includes a step of firing said green sheet.

13. A ceramic laminate manufacturing method according to claim 11, wherein an entire region between the inner wall of said processing chamber and said material sheet laminate is filled with said buffer material.

14. A ceramic laminate manufacturing method according to claim 11, wherein said pressurizing means includes a pair of pressurizing members which constitute a part of the wall of said processing chamber and pressurizes said material sheet laminate so as to be sandwiched from both sides in a stacking direction, and said buffer material is caused to intervene between said pair of pressurizing members and said material sheet laminate.

15. A ceramic laminate manufacturing method according to claim 11, wherein said material sheet laminate is composed of at least one dielectric ceramic material sheet and at least one magnetic ceramic material sheet which are stacked to each other.
